(19) United States
(12) Patent Application Publication
(10) Pub. No.: US 2009/0128101 A1
(43) Pub. Date: May 21, 2009

(54) POWER CONVERSION CIRCUIT

(75) Inventor: Andrew John Skinner, Devon (GB)

Correspondence Address: Studebaker & Brackett PC, 1890 Preston White Drive, Suite 105, Reston, VA, 20191, US

(73) Assignee: COUTANT LAMBDA LIMITED, Devon (GB)

(21) Appl. No.: 12/127,114

(22) Filed: May 27, 2008

(30) Foreign Application Priority Data
Jun. 4, 2007 (GB) 0710662.8

(51) Int. Cl. G05F 1/46

(52) U.S. Cl. 323/220

(57) ABSTRACT

A power conversion circuit comprising an input; an output; an electrical energy storage element having one side connected to the input; and at least two sub-circuits, wherein each respective sub-circuit is connected in series between the output and the other side of said electrical energy storage element; and wherein each said sub-circuit includes an inductive device, a rectifying element, and a controllable switching element connected in circuit therebetween to be capable of connecting the inductive device in parallel across the input; wherein the inductive elements of said at least two sub-circuits are magnetically coupled together. Smaller circuit components can therefore be used.

This invention relates to a power conversion circuit.

A known boost converter comprises an inductor connected between an input DC voltage and a switch so that the switch alternatively connects the inductor to the input voltage and to an output. The switch is driven at a particular duty cycle. The circuit provides an output voltage which is always greater or equal to the input voltage.

A buck converter is the same circuit operating in reverse so that the input voltage is always greater or equal to the output voltage. In what follows, the discussion revolves around boost converters although the same considerations apply to buck converters.

As the inductor in a boost converter is continuously charging and discharging, the resulting inductor current has an AC component termed a ripple current. Generally, such ripple currents are undesirable as they degrade component performance and introduce unwanted effects into the circuit.

One of the known ways of reducing these ripple currents is to increase the size of the inductor (relative to the operating voltages of the circuit). However, this suffers from the disadvantages of being bulky and expensive.

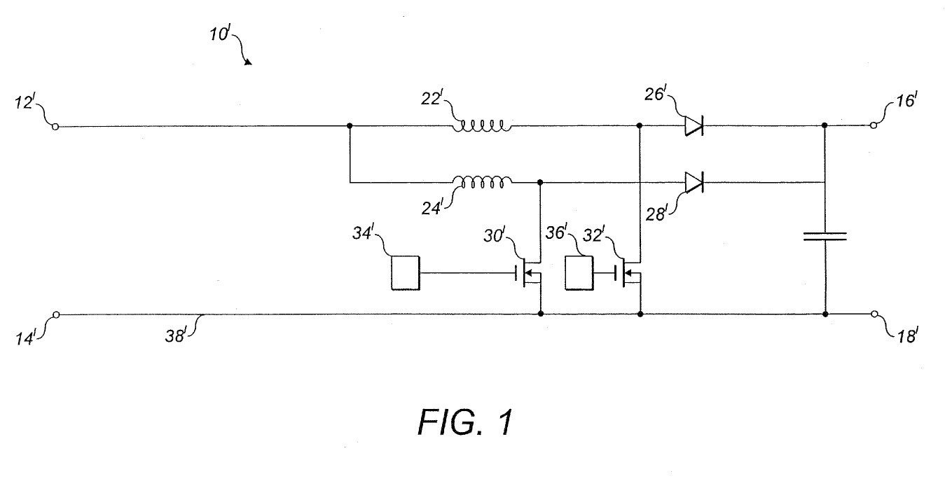

An alternative to using a large inductor is to operate two or more boost converter circuits in parallel, but with a phase shift between the switching of the respective switches. Such a circuit is known as an interleaved boost circuit and an example is illustrated in FIG. 1.

The interleaved boost converter 10′ comprises two sub-circuits, the first sub-circuit comprising inductor 22′, diode 26′ and switch 32′; and the second sub-circuit comprising inductor 24′, diode 28′ and switch 30′. Switch 30′ is controlled by a controller 34′ which switches the current flowing through inductor 24′ between a first path from an input 12′ returning to an input return terminal 14′ through diode 28′ and a second path from input 12′ returning directly to input return terminal 14′. Controller 36′ controls switch 32′ in a similar manner in respect of inductor 22′ and diode 26′. The term “interleaved” refers to the fact that the controllers 34′ and 36′ operate the respective switches 30′ and 32′ so that they are out of phase with one another. Each of the sub-circuits operate in the manner of known power conversion circuits and an output voltage is produced across outputs 16′ and 18′.

The phase shift between the operation of the two switches 34′ and 36′ results in the ripple currents of one of the boost converter sub-circuits cancelling the ripple currents of the other. This reduces the ripple current in both the input and the output. However, the ripple currents flowing in the components of a particular boost converter are not diminished by this arrangement and exhibit the aforementioned drawbacks.

A further example of an interleaved boost converter is provided in “Control Strategy of an Interleaved Boost Power Factor Correction Converter” Finheiro, J. R.; Grundling, H. A.; Vidor, D. L. R; Baggio, J. E. Power Electronics Specialists Conference, 1999, PESC 99. 30th Annual IEEE Volume 1, 27 Jul. 1999, vol. 1, pages 137-142.

It is therefore desirable to provide a power conversion circuit which minimizes ripple currents produced by the circuit and those ripple currents flowing through individual components of the circuit.

Furthermore, the higher the peak currents in the switches, the higher the conduction and turn-off losses. It is therefore also desirable to minimize the peak currents in the switches during operation of the circuit.

It is known from US-A-2006/0028186 to utilize a transformer in a boost converter to limit the voltage stress on the main switch thereby reducing switching losses and allowing a switch with a lower voltage rating to be used in the circuit.

According to a first aspect the invention provides for a power conversion circuit comprising an inductor for storing energy connected to at least two sub-circuits, each sub-circuit comprising a corresponding inductor, rectifier and switch, said switch being for providing a first current path through said corresponding inductor at a first voltage level and a second current path through said corresponding inductor and said corresponding rectifier at a second voltage level so that each sub-circuit provides, in use, a power conversion; wherein the energy storage inductor is connected to each of the inductors of the sub-circuits and an inductor of any one of said sub-circuits is magnetically coupled to an inductor of at least one other sub-circuit.

Where a DC input is applied to the power conversion circuit according to preferred embodiments of the invention, the magnetically coupled inductors operate with a direct current in each of the respective windings and the polarity of the phases of the magnetically coupled inductors are be such that the total DC magnetisation of the magnetic coupling is zero. Therefore smaller components can be used in circuits according to embodiments of the invention when compared to known power conversion circuits.

Furthermore, power conversion circuits according to embodiments of the invention display lower peak currents in the switches when compared to conventional power conversion circuits, and this reduces switching losses. Therefore circuits according to embodiments of the invention are more efficient and may be miniaturised to a greater extent than comparable known power conversion circuits.

An inductor of any one sub-circuit may be magnetically coupled to the inductors of each of the other sub-circuits.

The magnetically coupled inductors may comprise a transformer.

The transformer may be a multi-phase transformer wherein each sub-circuit is connected to a corresponding input phase of the transformer.

The magnetically coupled inductors and the energy storage inductor may be provided by an integrated component. This provides a more compact arrangement than having distinct magnetically coupled inductors and an energy storage inductor.

The power conversion circuit may comprise two sub-circuits wherein the controlling means is for switching the corresponding two switches with a phase difference of 180°.

Alternatively, the power conversion circuit may comprise more than two sub-circuits wherein the inductor of any one sub-circuit is coupled to the inductors of each of the other sub-circuits.

The power conversion circuit may then comprise n sub-circuits wherein the controlling means is for switching the corresponding switches with a phase difference of 360°/n.

The power conversion circuit may further comprise output filtering means.

The controlling means may be for using a peak current mode switching strategy.

The invention further extends to a boost converter incorporating a power conversion circuit as hereinbefore described.

The invention further extends to a buck converter incorporating a power conversion circuit as hereinbefore described.

According to a further aspect, the invention provides a power conversion circuit comprising a plurality of switching sub-circuits and a transformer, wherein all of the sub-circuits, in use, switch between two voltage levels and wherein each sub-circuit is connected to a corresponding input phase of said transformer and each output phase of the transformer is connected to a common node, said power conversion circuit further comprising means for controlling said switching of said sub-circuits to produce a switched current into or out of said common node.

The controlling means may be for switching said switches at a first frequency to produce said current at a second frequency, wherein said second frequency is less than the first frequency.

Examples of the present invention will now be described with reference to the accompanying drawings, in which:

FIG. 1 is a schematic diagram of a known power conversion circuit;

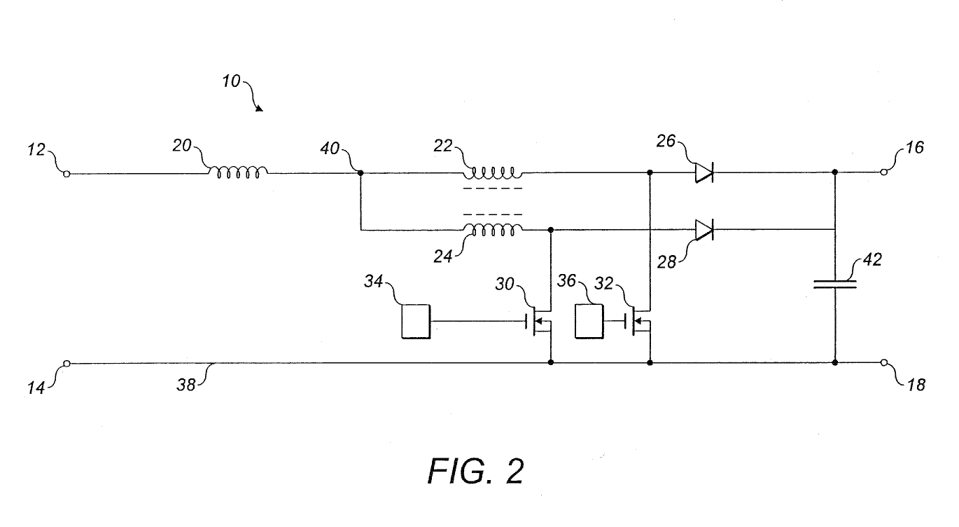

FIG. 2 is a schematic diagram of a power conversion circuit according to a preferred embodiment of the invention;

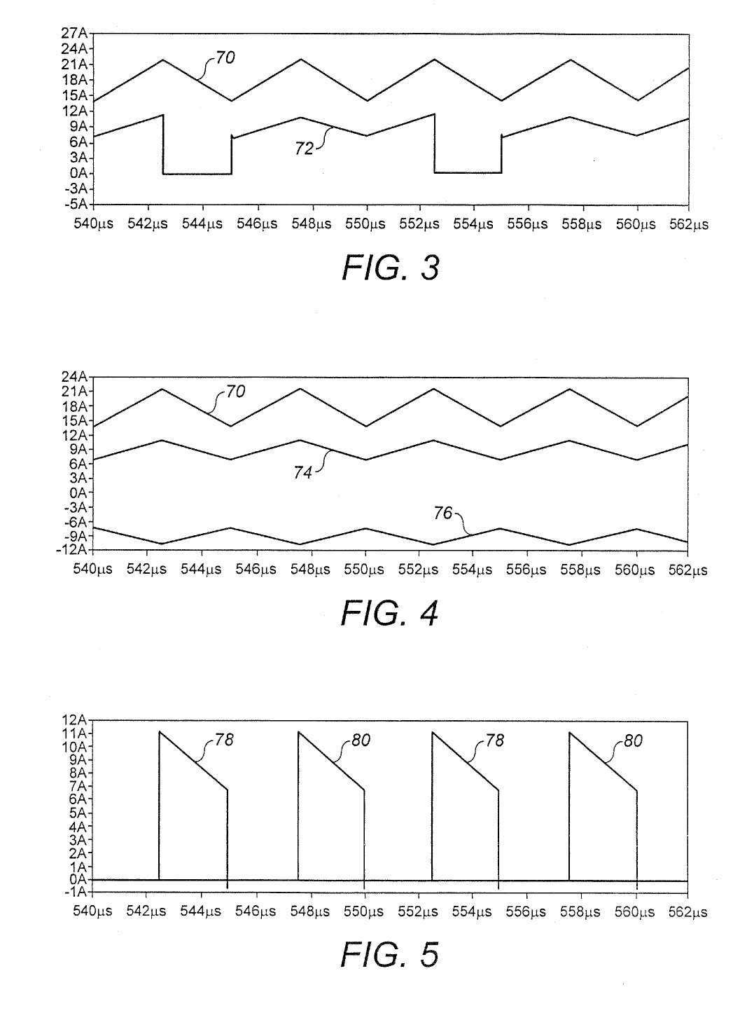

FIG. 3 is a graph of the currents in an inductor and a switch over time of the circuit of FIG. 2 operating in a first mode;

FIG. 4 is a graph of the currents in three inductors over time of the circuit of FIG. 2 operating in a first mode;

FIG. 5 is a graph of the currents in two diodes over time of the circuit of FIG. 2 operating in a first mode;

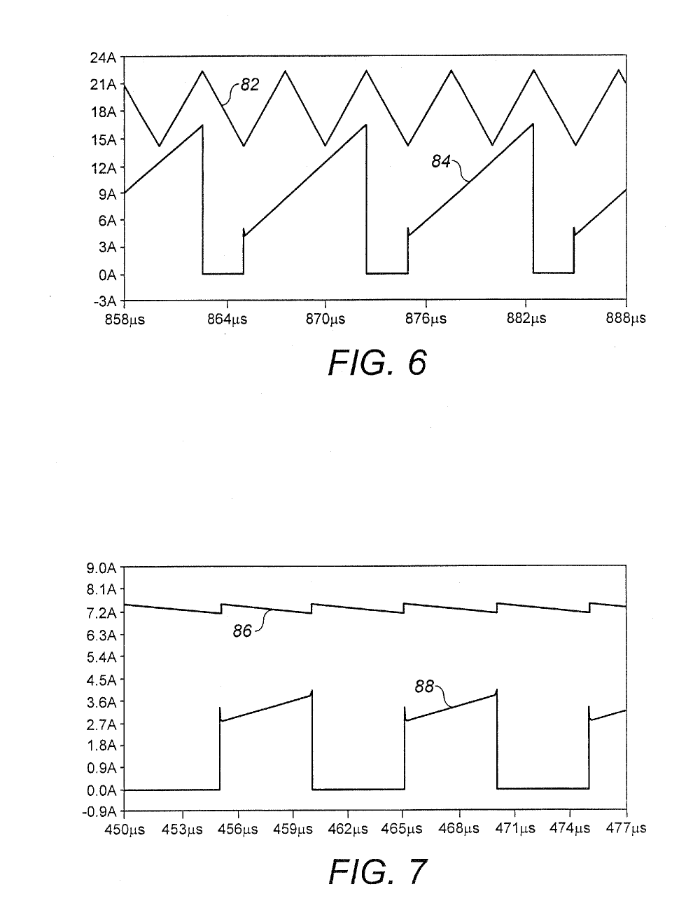

FIG. 6 is a graph of the sum of the currents in two inductors and in a switch over time of the conventional power conversion circuit of FIG. 1 operating in a first mode;

FIG. 7 is a graph of the currents in an inductor and in a switch over time of circuit of FIG. 2 operating in a second mode;

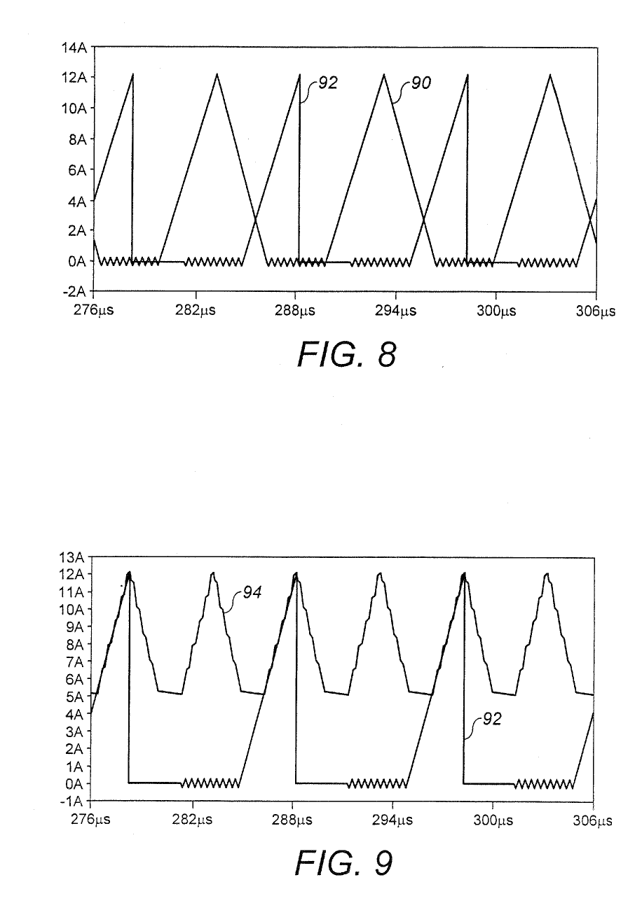

FIG. 8 is a graph of the currents in an inductor and in a switch of the conventional power conversion circuit of FIG. 1 operating in a second mode;

FIG. 9 is a graph of the currents in two inductors of the conventional power conversion circuit of FIG. 1 operating in a second mode; and

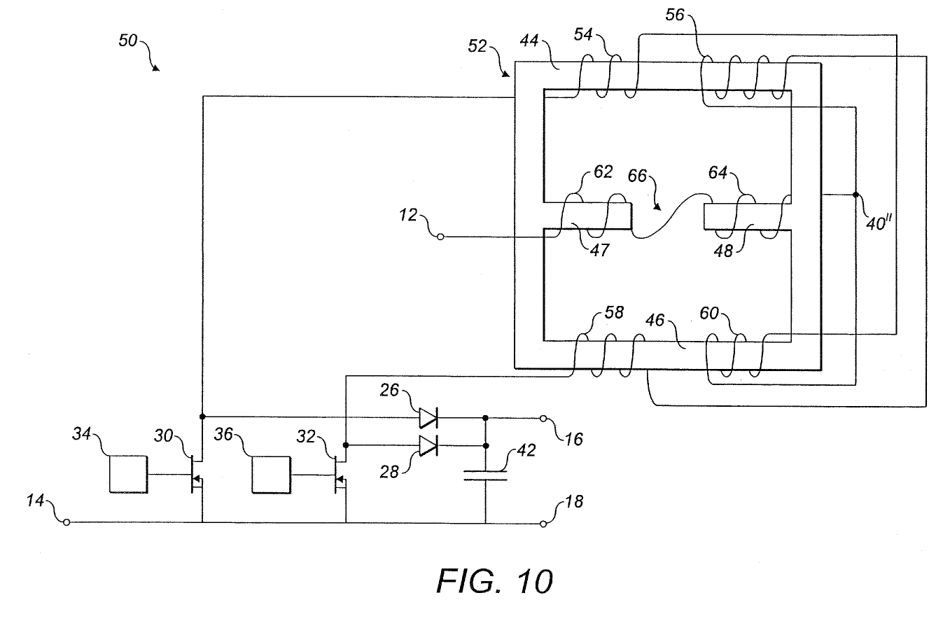

FIG. 10 is a schematic diagram of a power conversion circuit according to a further preferred embodiment of the invention.

FIG. 2 is a schematic diagram of a power conversion circuit according to a preferred embodiment of the invention in the form of a boost converter 10. The boost converter 10 includes input terminal 12 and input return terminal 14, and output terminals 16 and 18. A ground return line 38 connects input return terminal 14 to output terminal 18. The input terminal 12 is connected to a first inductor 20 which is connected to a node 40. Node 40 is, in turn, connected to a second inductor 22 which is also connected to the anode of a diode 26. The cathode of diode 26 is connected to the output terminal 16. Thus, a current path is formed from the input terminal 12 through the first inductor 20, through the node 40, through the second inductor 22 and diode 26, to the output terminal 16

Node 40 is also connected to a third inductor 24 which is also connected to the anode of a diode 28. The cathode of diode 28 is connected to the output terminal 16. Thus, a current path is formed from the input terminal 12 through the first inductor 20, through the node 40, through the third inductor 24 and diode 28, to the output terminal 16.

It will be noted that the second inductor 22 is magnetically coupled to the third inductor 24 by a ferrite core (schematically depicted by the dotted lines in FIG. 2).

The boost converter 10 further comprises a first switch 30, the drain terminal of which is connected to the junction between the third inductor 24 and the anode of diode 28. The source terminal of switch 30 is connected to the ground return line 38 connecting input return terminal 14 and output terminal 18. A controller 34 is connected to the switch 30 and delivers a pulse width modulated control signal to the switch 30.

The drain terminal of a second switch 32 is connected to the junction between the second inductor 22 and the anode of diode 26. The source terminal of switch 32 is connected to the ground return line 38 connecting input return terminal 14 and output terminal 18. A controller 36 is connected to the switch 32 and delivers a pulse width modulated control signal to the switch 32.

The controllers 34 and 36 each deliver a pulse width modulated control signal to the switches 30 and 32 to thereby dictate the duty cycles of these switches. Although the controllers 34 and 36 have been illustrated as distinct components, it is to be realised that the same functionality may be achieved by a single, integrated component.

Inductor 20, inductor 22, diode 26 and switch 32 comprise a first power conversion sub-circuit; whereas inductor 20, inductor 24, diode 28 and switch 30 comprise a second power conversion sub-circuit. Further sub-circuits may be provided where each sub-circuit includes an inductor magnetically coupled to inductors 22 and 24.

A capacitor 42 is connected across the output 16 and the output 18 and provides output filtering in a manner known in the art. Other forms of output filtering are also known, and may be used in conjunction with circuits according to embodiments of the invention.

The operation of the boost converter 10 will now be described. The operation of the circuit is best understood by considering the voltage at node 40.

In continuous mode, if both switch 30 and 32 are closed, the coupled inductors 22 and 24 act as a short circuit and the voltage at node 40 is approximately zero. If either of the switches 30 or 32 are open, the voltage at node 40 is a proportion of the output voltage across terminals 16 and 18 (the value depending on the values chosen for the second 22 and third 24 inductors). If both of the switches 30 and 32 are open, the voltage at node 40 is equal to the output voltage.

In discontinuous mode the switches of the circuit are operated so that during each cycle the current delivered to the load through diodes 28 and 26 decays to zero during the off-time of the switches 30 and 32. In this mode the voltage at node 40 will be constrained to a proportion of the output voltage (as determined by the values of inductors 22 and 24) until the current falls to zero at which time the voltage is applied across the first 20 and the second 22 inductors (if switch 32 is closed and switch 30 is open) or across the first 20 and the third 24 inductors (if switch 30 is closed and switch 32 is open).

After the current drops to zero, the input voltage is applied across inductors 20 and 22 or across inductors 20 and 24. Hence the gain of the circuit at light load can be set independently of the energy storage required for continuous mode operation. Inductor 20 can take a low value to reduce the energy stored but the value of the coupled inductors 22 and 24 (which can be significantly higher in inductance value) effectively sets the circuit duty-ratio to current gain at light load in discontinuous mode.

Where the coupled inductors 22 and 24 have a high inductance, the gain of the circuit will be reduced in discontinuous mode with no impact on the size of the coupled inductors, which will be based on thermal and flux density considerations.

The controllers 34 and 36 operate the respective switches 30 and 32 at particular duty cycles and the phase of the switching of one of the switches can be shifted relative to the switching of the other.

The coupled inductors have a winding ratio of 1:1. If the duty cycles of both switches is less than or equal to 50%, the switches are never on at the same time and node 40 will have values of Vout/2 and Vout. If the duty cycles of both switches are greater than 50%, node 40 will take values of 0V or Vout/2.

In both cases, it is to be realised that the number of volt seconds are significantly reduced across inductor 20 when compared to circuits known in the prior art, such as that illustrated in FIG. 1.

FIGS. 3 to 5 are graphs illustrating current fluctuation in various components of the boost converter 10 of FIG. 2 during continuous mode operation. To generate these graphs, the following values of the components have been chosen: the inductor 20 has a value of 21 μH and the values of the inductors 22 and 24 are both 400 μg. The diagrams illustrate the circuit operating at an input power of 1600 W and 90V. The switches 30 and 32 operate at a switching frequency of 100 KHz and at a duty cycle of 75% with a phase shift of 180° between them.

To produce the graphs illustrated in FIGS. 3 to 9, the corresponding circuits were operated with a phase difference of 180° between switches.

FIG. 3 illustrates the current in inductor 20 of FIG. 2, denoted by line 70, and the current in switch 32, denoted by line 72. FIG. 4 illustrates the current in inductor 20, line 70, compared to the current in inductor 22, line 74, and the current in inductor 24, line 76. FIG. 5 illustrates the current in the two diodes 26 and 28 (lines 78 and 80, respectively).

FIG. 6 is a graph produced by the operation of the conventional interleaved power conversion circuit illustrated in FIG. 1 operating in continuous mode. The Figure illustrates the operation of this conventional power conversion circuit where the inductors 22′ and 24′ each have a value of 50 μH and the switches 30′ and 32′ operate at a frequency of 100 KHz in continuous mode and at a duty cycle of 75% with a phase shift of 180° between them. The input power is approximately 1600 W. Line 82 of FIG. 6 illustrates the sum of the currents in the two inductors 22′ and 24′, whereas line 84 illustrates the current in the switch 32′ of FIG. 1.

A comparison of FIGS. 3 and 6 illustrates that the peak drain current in the switch 32 of the circuit according to the embodiment of the invention is much lower (72, FIG. 3), reaching 10.5 A instead of the peak 16 A shown in FIG. 6 (84). This illustrates the higher conduction and turn-off losses in the switches of the conventional circuit.

FIG. 7 is a graph produced by the same circuit which produced the graphs of FIGS. 3 to 5 operating at a 50% duty cycle. Line 86 depicts the current in the inductor 20 and line 88 depicts the current in switch 32.

FIG. 8 is a graph produced by the operation of the conventional interleaved power conversion circuit of FIG. 1 at the same loading conditions used to produce the graph of FIG. 7 where line 90 shows the current in the inductor 22′ of FIG. 1 and line 92 shows the current in the switch 30′ of FIG. 1 FIG. 9 is also a graph produced by the operation of the circuit illustrated in FIG. 1 and shows the current in both inductors 20′ and 22′ of FIG. 1 (line 94), and the current in the switch 32′ (line 92), over time.

FIG. 8 illustrates the discontinuous inductor current leading to incomplete cancellation at the input of the conventional power conversion circuit. It can be seen that current in inductor 22′ falls to approximately zero during part of the switching cycle and therefore no cancellation of the current in inductor 24′ can take place.

As illustrated in FIG. 9, the conventional power conversion circuit operates with a peak-to-peak ripple in the input current of approximately 5 A for the aforementioned operating parameters and component values. The ripple current in inductor 20 (line 86, FIG. 7) of an embodiment of the invention has been almost completely cancelled. To achieve a similar near-continuous current in the inductor using the conventional topology would require inductors rated at more than 115 μH.

As can be seen there are significantly lower peak currents operating in the switches of the circuit according to an embodiment of the invention, when compared to a conventional power conversion topology, resulting in significantly lower conduction and turn-off losses. Furthermore, embodiments of the invention demonstrate ripple cancellation in the inductors with lower rated components than would be needed in traditional circuits. Therefore embodiments of this invention result in a significant 3C reduction in energy storage component size and switch losses. The use of smaller components provides for circuits with better integration and smaller profiles.

FIG. 10 illustrates a power conversion circuit 50 according to a further preferred embodiment of the invention where like numerals have been used to denote like components to those illustrated in FIG. 2.

The power conversion circuit 50 includes a magnetic core 52 in the shape of a capital ‘E’ connected at the top and bottom limbs to a mirror image capital ‘E’ to form an upper limb 44 and a lower limb 46. Two centre limbs 47 and 48 define an air gap 66 between them. The core 52 is provided with windings 54 and 56 on the upper limb 44 and windings 58 and 60 on the lower limb 46. The two central limbs 47 and 48 defining air gap 66 are each provided with corresponding windings 62 and 64.

The core with windings 54, 56, 58, 60, 62 and 64 replaces the inductors 20, 22 and 24 of FIG. 1. Winding 54 on the upper limb 44 of the core 52 is connected to the drain terminal of switch 30 and to winding 60 on the lower limb 46 of core 52. Winding 60 is, in turn, connected to a node 40″ which is connected to winding 56 on the upper limb 44. Winding 56 is connected to winding 58 on the lower limb 46 of core 52. Winding 58 is connected to the drain terminal of switch 32.

The node 40″ is connected to winding 64 on centre limb 48 of the core 56 which is further connected, across air gap 66, to winding 62 on the centre limb 47 of core 52. Winding 62 is connected to input 12.

The connections are such that current can flow from the input 12, through windings 62 and 64 to node 40″. From node 40″ the current can flow through winding 56 and through winding 58 to the drain terminal of switch 32. Current can also flow from node 40″ to winding 60 and then through winding 54 to the drain terminal of switch 30. The anode of diode 26 is connected to the junction between the drain terminal of switch 30 and winding 54. The anode of diode 28 is connected to the junction between the drain terminal of switch 32 and the winding 58. The remaining connections and components of the circuit illustrated in FIG. 10 are the same as those of the circuit illustrated in FIG. 2.

Windings 54, 56, 58 and 60 act as coupled inductors and the windings 62 and 64 act as an energy storage inductor in use of the power conversion circuit 50. The air gap 66 stores energy, but it is to be realised that an air gap is not necessary and that other core materials may be used.

The circuit of FIG. 10 acts in the same manner as that of FIG. 2 and the above description with reference to node 40 of FIG. 2 applies equally in respect of node 40″ of FIG. 10. The core 52 provides an integrated component for magnetically coupled inductors (windings 54, 56, 58 and 60) and an energy storage inductor (windings 62 and 64).

Magnetic flux from the windings providing magnetically coupled inductors (54, 56, 58 and 60) travels around the connected upper and lower limbs and DC-flux from the energy storage inductor (windings 62 and 64) flows in the centre limbs. AC-flux from the energy storage inductor causes a net increase in the AC-flux in one outer limb (upper 44 or lower 46 limb) and a net decrease in the other. The impact of this flux imbalance is cancelled by winding half of the turns for each winding providing the magnetically coupled inductors on each of the two outer limbs (as shown). If C however the AC-flux from the energy storage inductor is low, then the complete winding for the magnetically coupled inductors may be wound on the outer limbs. The number of windings shown in FIG. 10 may be varied accordingly.

As the integrated component 52 shares core material between the magnetically coupled inductors and the energy storage inductor, the circuit of FIG. 10 can be miniaturised to a greater extent than that of FIG. 2.

In the embodiments illustrated in FIGS. 2 and 10, the coupled inductors have a winding ration of 1:1 to cancel the fundamental frequency.

1. A power conversion circuit comprising:—
an input;
an output;
an electrical energy storage element having one side connected to the input; and
at least two sub-circuits, wherein each respective sub-circuit is connected in series between the output and the other side of said electrical energy storage element; and
wherein each said sub-circuit includes an inductive device, a rectifying element, and a controllable switching element connected in circuit therebetween to be capable of connecting the inductive device in parallel across the input;
wherein the inductive elements of said at least two sub-circuits are magnetically coupled together.

2. A power conversion circuit of claim 1 wherein the electrical energy storage element comprises an inductive element.

3. A power conversion circuit according to claim 1 wherein the inductive devices of all sub-circuits are substantially the same.

4. A power conversion circuit according to claim 1 wherein the magnetically coupled inductors and the electrical energy storage element are provided as an integrated magnetic component.

5. A power conversion circuit according to claim 1 comprising three or more sub-circuits wherein the inductor device of any one sub-circuit is magnetically coupled to the inductor devices of each of the other sub-circuits.

6. A boost converter incorporating a power conversion circuit according to claim 1.

7. A buck converter incorporating a power conversion circuit according to claim 1.

8. A power conversion circuit comprising an energy storage inductor for storing electrical energy connected to at least two sub-circuits, each sub-circuit comprising a respective inductor, rectifier and switch, wherein said switch is connected to said rectifier and to said inductor to provide a first current path through said inductor and a second current path through said inductor and said rectifier so that each sub-circuit provides, in use, a power conversion; wherein the energy storage inductor is connected to each of the respective inductors of the sub-circuits and an inductor of any one of said sub-circuits is magnetically coupled to the inductors of each other sub-circuit.
